(19) United States
(12) Patent Application Publication
(10) Pub. No.: US 2015/0356613 A1
(43) Pub. Date: Dec. 10, 2015

(54) Providing Promotional Information Related to Modes of Transportation

(71) Applicant: Fred Fang, San Francisco, CA (US)

(72) Inventor: Fred Fang, San Francisco, CA (US)

(73) Assignee: GOOGLE INC., Mountain View, CA (US)

(21) Appl. No.: 12/956,721

(22) Filed: Nov. 30, 2010

(51) Int. Cl. G06Q 30/02; G01C 21/00

(52) U.S. Cl. CPC G06Q 30/0265; G01C 21/00

(57) ABSTRACT

In one implementation, a computer-implemented method includes receiving at a server system a request from a client computing device for directions from a start geographic location to a destination geographic location; and identifying by the server system at least one mode of transportation from a plurality of modes of transportation for traveling from the start geographic location to the destination geographic location. The method can also include selecting by the server system promotional information related to the identified at least one mode of transportation to provide to the client computing device; and providing by the server system and to the client computing device the selected promotional information with directions to guide a user of the client computing device from the start geographic location to the destination geographic location.

### TECHNICAL FIELD

This document generally describes techniques, methods, and systems for providing promotional information such as advertisements to a client computing device.

### BACKGROUND

Various computer server systems provide web browser-based map and direction services. With such a system, a client computing device can submit an electronic request over a network (e.g., Internet, local area network (LAN), etc.) to the system and receive an electronic document (e.g., a web page) that includes maps and/or directions (e.g., driving directions, biking directions, walking directions, etc.) in response. For example, a client computing device (e.g., a laptop computer, a smart phone, a mobile phone, a tablet, etc.) can send a request to a computer server system for driving directions from San Francisco to Seattle and receive a web page (e.g., a hypertext markup language (HTML) document, etc.) in return that contains a map with turn-by-turn directions from San Francisco to Seattle.

Promotional information (e.g., ads, public service announcements, etc.) has been provided in conjunction with such web-based map and direction services. For instance, a web-based advertisement (e.g., HTML code, an image file, interactive application, etc.) for a hotel in Seattle can be provided with the turn-by-turn directions from San Francisco to Seattle.

### SUMMARY

This document describes techniques for providing promotional information associated with to modes of transportation (e.g., automobile, airplane, train, etc.). A mode of transportation is a manner by which a person (or other physical object) travels between geographic locations, such as cars, trains, buses, and/or airplanes. Promotional information associated with modes of transportation can be provided with maps and/or directions, and can be selected based on the maps and/or directions with which the promotional information is being provided. For example, if a client computing device submits an electronic request for a driving direction from San Francisco to Seattle, promotional information associated with modes of transportation for travelling from San Francisco to Seattle can be provided with and selected based on the driving directions. For instance, an ad for flights from San Francisco to Seattle can be provided with the driving directions from San Francisco to Seattle.

In one implementation, a computer-implemented method includes receiving at a server system a request from a client computing device for directions from a start geographic location to a destination geographic location; and identifying by the server system at least one mode of transportation from a plurality of modes of transportation for traveling from the start geographic location to the destination geographic location. The method can also include selecting by the server system promotional information related to the identified at least one mode of transportation to provide to the client computing device; and providing by the server system and to the client computing device the selected promotional information with directions to guide a user of the client computing device from the start geographic location to the destination geographic location.

In another implementation, a system for providing promotional information to a client computing device in response to a request for directions includes one or more servers, and an interface for the one or more servers to receive a request from the client computing device for directions from a start geographic location to a destination geographic location. The system can also include a mode of transportation component to identify at least one mode of transportation for traveling from the start geographic location to the destination geographic location. The system can further include a promotional information module to select promotional information related to the identified at least one mode of transportation and to provide to the client computing device the selected promotional information with directions from the start geographic location to the destination geographic location.

In another implementation, a system for providing promotional information to a client computing device in response to a request for directions includes one or more servers, and an interface for the one or more servers to receive a request from the client computing device for directions from a start geographic location to a destination geographic location. The system can also include means for identifying at least one mode of transportation for traveling from the start geographic location to the destination geographic location. The system can further include a promotional information module to select promotional information related to the identified at least one mode of transportation and to provide to the client computing device the selected promotional information with directions from the start geographic location to the destination geographic location.

The details of one or more embodiments are set forth in the accompanying drawings and the description below. Various advantages can be provided. For example, users can be provided with more relevant promotional information. For instance, a user who is interested in travelling from a start location to a destination location may be more interested in promotional information related to a mode of transportation from the start location to the destination location than in an alternate start and/or destination location—the user already knows that he/she wants to travel from point A to point B and may have little interest in promotional information related to point C. Instead, the user can be provided with promotional information that may provide options for travelling from point A to point B that the user may not have known about.

In another example, parties whose services/products related to modes of transportation that are being promoted in promotional information may be more likely to reach interested users. Users may be more likely to select such promotional information and ultimately purchase/use the promoted service/product based on the promotional information that is more contextually relevant to users (e.g., promotional information related to a mode of transportation from a start to a destination location with directions from the start location to the destination location), as indicated above.

Additionally, parties who provide promotional information for presentation to users may experience an increased benefit, such as increased revenue, by providing promotional information related to modes of transportation. For instance, such providers may receive revenue when users viewing promotional information convert promotional information views (e.g., select a link provided with the promotional information to receive more information, interact with the promotional information, etc.). Users provided with more relevant promotional information related to modes of transportation may be more interested in such promotional information, as indicated above, and may be more likely to seek additional information by converting the promotional information into revenue for the promotional information provider.

Other features, objects, and advantages of the invention will be apparent from the description and drawings, and from the claims.

### DESCRIPTION OF DRAWINGS

FIG. 1 is a conceptual diagram of an example system for providing promotional information with navigational directions based upon modes of transportation.

FIG. 2 is a diagram of an example system for providing promotional information based upon modes of transportation.

FIGS. 3A-B depict a flowchart showing an example technique for providing promotional information based upon modes of transportation.

FIGS. 4A-B are screenshots of an example application providing mode of transportation-related promotional information with directions.

FIG. 5 is a block diagram of computing devices that may be used to implement the systems and methods described in this document, as either a client or as a server or plurality of servers.

Like reference symbols in the various drawings indicate like elements.

### DETAILED DESCRIPTION

This document generally describes techniques, methods, systems, and computer program products for providing promotional information (e.g., ads, public service announcements, etc.) related to modes of transportation (e.g., car, bus, airplane, boat, etc.) for traveling from a start location to a destination location. More specifically, this document describes techniques, methods, systems, and computer program products for providing mode of transportation-related promotional information for display with electronic documents and/or applications related to traveling from a start location to a destination location (e.g., browser-based maps and/or driving directions, travel reservation web pages, travel related mobile phone applications, etc.).

For example, assume that a user requests driving directions from the user's home address in San Francisco (an example start location) to a friend's home address in Los Angeles (an example destination location) from a website that provides a map and driving directions service (e.g., YAHOO! MAPS, BING MAPS). In response, the user can receive a web page (e.g., HTML document) that includes turn-by-turn directions from the user's home in San Francisco to the friend's home in Los Angeles and a map highlighting the suggested route. Ads related to the San Francisco and/or Los Angeles may be included with the driving directions and the map on the web page. For instance, the user may be presented with an ad for a hotel in Los Angeles.

However, location-based ads that promote alternate start or destination locations may be irrelevant to a user who is interested in traveling from a specific start location to a specific destination location. For instance, expanding upon the previous example, the ad for the hotel in Los Angeles promotes an alternate destination location to the user—the hotel in Los Angeles instead of the friend's home in Los Angeles. As demonstrated by the user's request for driving directions, the user is interested in finding out how to travel from the user's home in San Francisco (start location) to the friend's home in Los Angeles (destination location), not in identifying a different destination location.

Instead, a user who is interested in traveling between locations may find promotional information that is related to a mode of transportation for traveling between the locations to be more relevant than promotional information that is related to an alternate location. For instance, referring to the previous example, instead of presenting the user with an ad for a hotel in Los Angeles with the requested driving directions, the user can be presented with an ad regarding airfare for flying roundtrip from San Francisco to Los Angeles. Given that the user is interested in figuring out how to travel between San Francisco and Los Angeles, the user may be more interested in the airfare ad than the hotel ad.

Transportation-related promotional information can be selected based on location(s) for a map and/or directions with which the promotional information is being provided. For instance, if promotional information is being provided with directions from a start location to a destination location, one or more modes of transportation can be identified based on, at least, the start location and the destination location. For example, if a user has requested directions from San Francisco to Los Angeles, it may be appropriate to provide promotional information related to longer-distance modes of transportation, like airplanes. However, if a user has requested directions from San Francisco to San Jose, Calif., it may be appropriate to provide promotional information related to shorter-distance modes of transportation, like public transportation (e.g., commuter bus and rail lines). Various criteria can be used to determine which modes of transportation are appropriate (e.g., likely to be of interest to a user) given one or more locations presented on a map and/or directions, such as a distance between locations and/or modes of transportation that are associated with promotional information that was previously selected by users (e.g., indications of modes of transportation that users previously found to be relevant to a map and/or directions).

Promotional information can be selected to target a mode of transportation that is an alternative to a mode of transportation that is a subject of a map and/or directions. For example, if a user requests directions for driving an automobile from San Francisco to Los Angeles, the user may be more interested in promotional information that provides an alternative to driving an automobile than in promotional information related to driving (e.g., ads for car rentals). For instance, a user can be provided with promotional information regarding alternative modes of transportation from San Francisco to Los Angeles, such as ads for airplane flights and ads for bus fares.

Modes of transportation can include a variety of ways to travel between locations, such as machine powered modes of transportation (e.g., cars, airplanes) and human powered modes of transportation (e.g., bicycle, walking). For example, modes of transportation can include cars, taxis, buses, trains (e.g., AMTRAK, subways, light-rail trains, personal rapid transit, etc.), boats (e.g., ferries, cruise ships, etc.), airplanes, bicycles, walking/hiking, and/or motorcycles. These example modes of transportation, as well as other modes of transportation not mentioned, can be used to target promotional information to users.

Promotional information that is related to modes of transportation can be provided with a variety of documents and/or applications. For example, such promotional information can be provided with web pages (example documents) displaying maps and/or navigational directions. In another example, such promotional information can be provided with a document that includes results for a search query that is determined to be related to travelling between locations. For example, if a user submits the search query “England trip” to a search engine, the search query can be determined to be related to travelling from the user's current geographic location (e.g., city, geographic positioning system (GPS) coordinates, country, street address, etc.) to England. Promotional information related to modes of transportation between the user's current geographic location and England can be provided to the user, such as ads for airplane flights and cruise ships. A user's geographic location can be determined from any of a variety of techniques, such as associations between a user's internet protocol (IP) address and geographic location, GPS information, and/or wireless signal (e.g., cellular network signal, 3G/4G signal) triangulation.

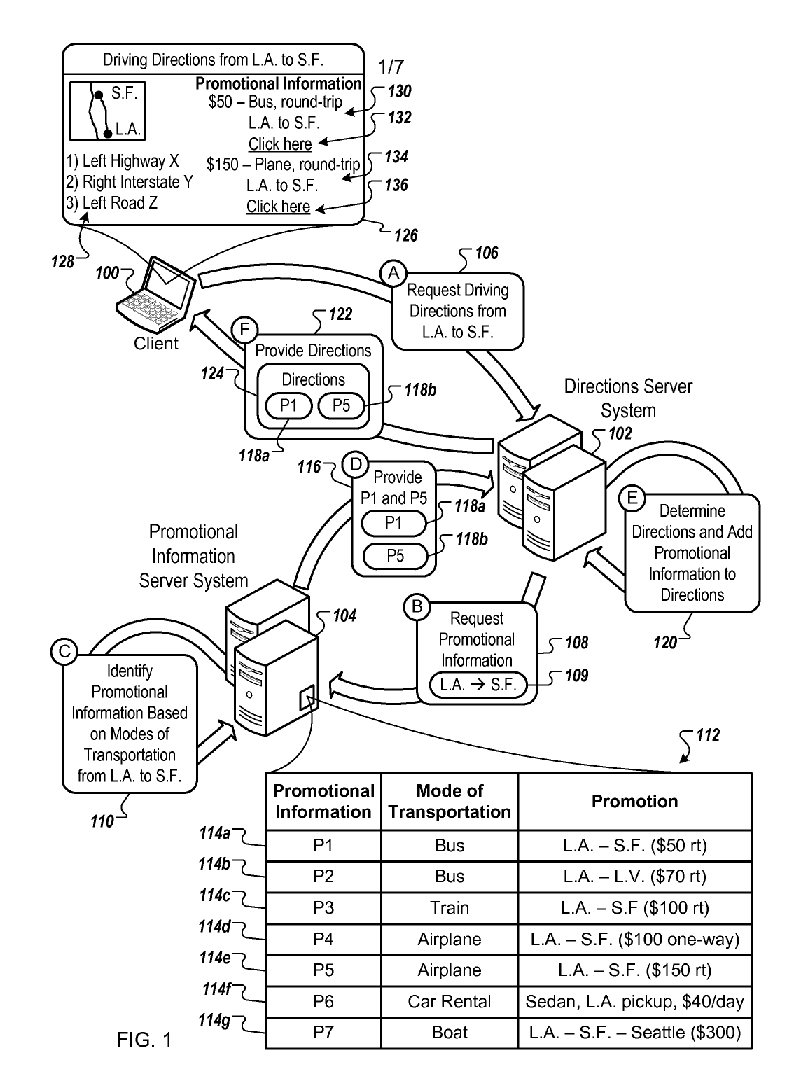

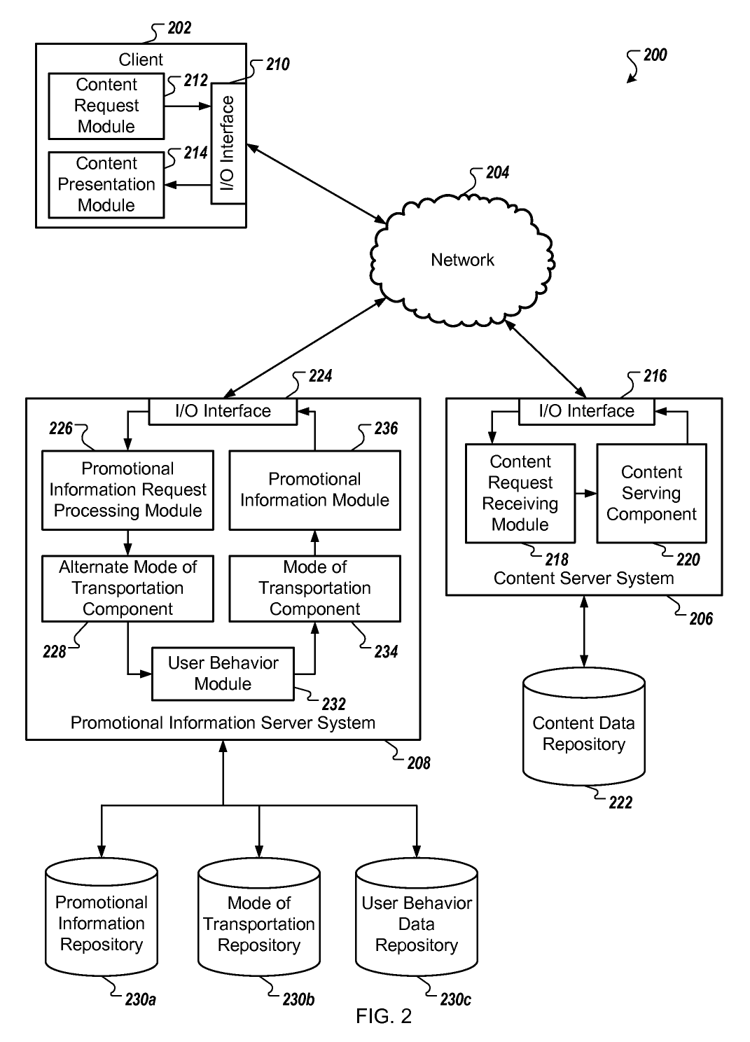

FIG. 1 is a conceptual diagram of an example system for providing promotional information with navigational directions based upon modes of transportation. FIG. 1 depicts an example client computing device 100 that requests driving directions from a directions server system 102. As part of serving the request from the client computing device 100, the directions server system 102 interacts with a promotional information server system 104 that is configured to select and provide promotional information based on modes of transportation for travelling between the locations specified in the request.

The client computing device 100, the directions server system 102, and the promotional information server system 104 can each be any of a variety of computing devices, such as a laptop computer, a desktop computer, a mobile telephone, a smart phone, a computer server system, or any combination thereof. The client computing device 100, the directions server system 102, and the promotional information server system 104 can communicate through any of a variety of communications channels, such as the Internet, a local area network (LAN), a wide area network (WAN), a virtual private network (VPN), a wireless network (e.g., wifi, cellular telephone network, 3G/4G data network, etc.), or any combination thereof.

As depicted at step A (106) in the example, the client computing device 100 provides a request to the directions server system 102 for driving directions from Los Angeles (L.A.) to San Francisco (S.F.). The client computing device 100 may have previously received an electronic document (e.g., a web page) and/or an application (e.g., standalone directions application, web browser, etc.) through which the request was generated by a user of the client computing device 100. For example, a user of the client computing device 100 may have previously requested a directions home page that is hosted by the directions server system 102 and that contains a form that can be used to request directions (e.g., start location field, destination location field, submit button, etc.). In response to the user of the client computing device 100 entering Los Angeles and/or San Francisco into the form and performing an action to trigger the request (e.g., select the submit button, complete the fields of the form, etc.), the client computing device 100 can cause the request to be transmitted to the directions server system 102.

In response to receiving the request, the directions server system 102 can begin to serve the request. Serving such a request can include determining the requested directions and selecting promotional information to provide with the directions. As indicated by step B (108), the directions server system 102 can request promotional information to provide with the driving directions from the promotional information server system 104. The directions server system 102 can include information 109 with the request regarding the directions that the promotional information will be provided with, such as a start location (L.A.) and a destination location (S.F.). Additional information not depicted can be included with the request, such as a mode of transportation for which the map and/or directions are being provided by the directions server system 102.

As indicated by step C (110), the promotional information server system 104 can identify promotional information to provide with the requested driving directions based on modes of transportation from Los Angeles to San Francisco. The promotional information server system 104 can use, at least, the information 109 included in the request and table 112 that associates promotional information with modes of transportation and locations to identify promotional information to provide to the directions server system 102. In this example, the table 112 includes entries 114a-g for promotional information P1-P7, respectively. The entries 114a-g indicate a mode of transportation that is associated with promotional information (e.g., a mode of transportation for the product/service being promoted by the promotional information) and information regarding the corresponding promotion (e.g., start location, destination location, price, round-trip or one-way, etc.). The table 112 can be part of a data repository (e.g., database) and can include a variety of other fields and/or information, such as a start location field, a destination location field, a timeframe during which the promotion is valid, and/or bids for the opportunity to display the promotional information to a user (e.g., an bid from an advertiser to present an ad to a user).

The table 112 is depicted as including example entries 114a-g for promotional information P1-P7. Entry 114a indicates that promotional information P1 regards a round-trip bus trip from Los Angeles to San Francisco for $50, and entry 114b indicates that promotion P2 regards a round-trip bus trip from Los Angeles to Las Vegas (L.V.) for $70. Entry 114c indicates that promotional information P3 regards round-trip train transportation from Los Angeles to San Francisco for $100. Entry 114d indicates that promotional information P4 regards one-way airfare from Los Angeles to San Francisco for $100, and entry 114e indicates that promotional information P5 regards round-trip airfare from Los Angeles to San Francisco for $150. Entry 114f indicates that promotional information P6 regards a car rental offer for Los Angeles pickup at a rate of $40/day. Entry 114g indicates that promotional information P7 regards an offer for a boat cruise from Los Angeles to San Francisco, and continuing on to Seattle for $300.

In response to receiving the request for promotional information from the directions server system 102, the promotional information server system 104 can determine whether to provide mode of transportation-related promotional information. For instance, the promotional information server system 104 may be configured to serve a variety of promotional information, including promotional information that is not related to modes of transportation (e.g., location-based promotional information). The promotional information server system 104 can determine whether mode of transportation-related promotional information would likely be relevant to a user of the client computing device 100. Such a determination can be based on a variety of factors, such as whether the request from the client computing device 100 relates (explicitly or implicitly) to travelling between locations and/or whether users have previously found mode of transportation-related promotional information to be relevant when presented in response to requests similar to the request from the client computing device 100.

Regarding the first example factor (request relates to travelling), a request from the client computing device 100 regarding travelling can indicate that a user of the client computing device 100 is currently interested in modes of transportation between locations. The promotional information server system 104 can determine whether a request relates to travelling between locations. For instance, some requests can explicitly relate to travelling between locations, such as a request for directions between locations and a request for airfare information between two locations. Some requests can be determined to implicitly relate to travelling between locations, such as a request for a map and/or a search query for vacation destination (e.g., search query “vacation Mexico”). Start and/or destination locations can be inferred if not specified. For instance, if client computing device 100 located in Boston, Mass., provides a request for a map of New York, N.Y., to the directions server system 102, the destination location can be identified from the request as New York and the start location can be determined from the current geographic location of the device 100 (Boston).

Systems other than the directions server system 102 can provide requests for promotional information to the promotional information server system 104 for which mode of transportation-related promotional information is provided. For example, a search engine server system (not depicted) can provide requests for promotional information to the promotional information server system 104. As indicated above, the content of a search query can be analyzed to determine, at least in part, whether mode of transportation-related promotional information is likely to be relevant to a user who provided a search query. Other server systems not mentioned in this document can also provide requests to the promotional information server system 104 and receive mode of transportation-related promotional information in return.

Regarding the second example factor mentioned above (whether users have previously found mode of transportation-related promotional information to be relevant), the promotional information server system 104 can access user behavior data that indicates how users have interacted with previously provided mode of transportation-related promotional information. Interaction can include a variety user action, such as a user clicking on a link provided with the promotional information, a user selecting a play button for a video included with the promotional information, and/or a user playing an interactive game included as part of the promotional information. User interaction with promotional information can indicate that a user has previously found promotional information to be relevant to his/her request (e.g., request for directions, request for a map, search query, etc.). User behavior data, which is anonymized to protect user privacy, can be used to identify situations (e.g., requests for directions, search queries related to travel, etc.) when users have previously found mode of transportation-related promotional information to be relevant to a request. The promotional information server system 104 can present mode of transportation-related promotional information in situations similar to the relevant situations identified based on user behavior data.

For example, assume that the promotional information server system 104 has provided mode of transportation-related promotional information to a variety of client computing devices in a variety of different situations (e.g., search queries, driving directions, map request, etc.) and that user behavior data is obtained based on user interaction with the promotional information (e.g., unique identifier included in link user selects, etc.). If the user behavior data indicates that user interaction with the mode of transportation-related promotional information has occurred predominantly when a user has received the promotional information in response to a request for driving directions exceeding 300 miles, then the promotional information server system 104 can provide mode of transportation-related promotional information in response to requests for driving directions exceeding 300 miles.

Factors for determining when to present mode of transportation-related promotional information other than the two factors mentioned above may also be employed when appropriate.

The promotional information server system 104 can select one or more of the promotional information P1-P7 to provide to the directions server system 102 with the requested directions. The aim of the promotional information server system 104 can be to select promotional information that is likely to be relevant to the user of the client computing device 100 that is requesting the driving directions. The promotional information server system 104 can make such a selection based on a variety of factors, such as whether the promotional information pertains to a mode of transportation for travelling to/from one or more of the locations specified in the request from the client computing device 100 (or other locations within a threshold distance of the specified locations), a distance between the start and destination locations, and/or user behavior data indicating promotional information that users have previously found to be relevant in response to similar requests.

For example, the promotional information server system 104 can select promotional information that pertains to the start and/or destination location, such as the promotional information P1 for a bus trip from Los Angeles to San Francisco, as indicated by entry 114a. The promotional information P2 for a bus trip from Los Angeles to Las Vegas, as indicated by entry 114b, may not be as relevant to the request from client computing device 100 as promotional information P1 based on the promotional information P2 providing an alternate destination location (Las Vegas).

In another example, the promotional information server system 104 can select promotional information based on a distance between a start and destination location. For example, mode of transportation information related to airfare may be provided when a distance between the start and destination locations exceeds a threshold distance, such as 100 miles, 200 miles, 300 miles, 500 miles, and/or 1000 miles. Various distance thresholds associated with one or more modes of transportation can be used to select promotional information. For example, promotional information related to bus travel may be selected when the distance between the start and destinations locations is less than 1000 miles, 500 miles, 250 miles, and/or 150 miles.

In a further example, the promotional information server system 104 can use user behavior data to select promotional information to provide to the client computing device 100. Similar to the discussion of user behavior data above, the promotional information server system 104 can analyze user behavior data to determine which of the promotional information P1-P7 is likely to be relevant given the request from the client computing device 100. For example, if other users requesting driving directions from Los Angeles to San Francisco (or between locations nearby L.A. and S.F., or between locations separate by a similar distance) have interacted with airfare promotions (e.g., P4 and P5) with the greatest amount of frequency, then the promotional information server system 104 can select promotional information related to modes of transportation by airplane between Los Angeles and San Francisco.

The promotional information server system 104 can also take into account bids from parties (e.g., advertisers) providing promotional information. For instance, parties may express their interest in having their respective promotional information provided to a user in an amount they are willing to pay to have their promotional information provided to a user. With multiple parties competing for a limited number of opportunities to provide promotional information to a user, a mechanism such as an auction can be used to award opportunities to parties. Auctions can take a variety of forms.

In one example, an auction can take into consideration that relevance and quality of promotional information (e.g., quality of content of promotional information) to balance the interests of parties providing promotional information with the interests of users viewing the promotional information—users would like to see high quality advertisements that are relevant to the users' current interests. As part of such an auction, promotional information can be scored based on an expectation that, given the request from the client computing device 100, that a user of the client computing device 100 will interact with the promotional information. Such a score can be termed a “click through” rate or score. A variety of factors, including those discussed in the examples above, can be used to determine a likelihood that a user will interact with mode of transportation-related promotional information. Scores and bids for promotional information can be combined (e.g., multiplied, added, etc.) and the combinations can be ranked. Promotional information can be selected based on the ranking (e.g., select the top 1, 2, 3, 5, etc. ranked promotional information) and/or on the combined score (e.g., select promotional information having at least a threshold combined score).

In the example depicted in FIG. 1, the promotional information server system 104 selects the promotional information P1 (114a) and the promotional information P5 (114e) regarding a round-trip bus fare and airfare from Los Angeles to San Francisco, respectively. The selection can be based on one or more of the selection techniques described above. For instance, the promotional information server system 104 can attempt to display alternative modes of transportation from the start location (Los Angeles) to the destination location (San Francisco) to the mode of transportation the user is currently considering for the trip (driving an automobile). In this example, the promotional information P1 regarding travelling by bus and the promotional information P5 regarding travelling by airplane can be selected to provide the user with alternatives to driving between Los Angeles and San Francisco.

As indicated at step D (116), the promotional information server system 104 can provide the selected promotional information P1 and P5 (118a-b) to the directions server system 102. The directions server system 102 can determine directions for the route requested by the client computing device 100 and add the promotional information P1 and P5 to the directions (e.g., add code to a web page that causes the promotional information P1 and P5 to be retrieved and/or displayed with the directions), as indicated by step E (120).

As indicated by step F (122), the directions server system 102 provides the directions 124 with the promotional information P1 and P5 (118a-b) to the client computing device 100 for presentation to a user of the client computing device 100. The directions 124 and the promotional information 118a-b can be provided in any of a variety of electronic data formats, such as HTML, extensible markup language (XML), SHOCKWAVE/FLASH, JAVASCRIPT, and/or HTMLS.

Using any of a variety of applications installed (as software and/or hardware) on the client computing device 100, the directions 124 and the promotional information 118a-b can be provided (e.g., displayed, audibly played, etc.) to a user of the client computing device 100. An example of the directions 124 and the promotional information 118a-b being provided on the client computing device 100 is depicted as display 126. The display 126 includes driving directions 128 from Los Angeles to San Francisco (map and turn-by-turn directions). The display 126 also includes promotional information 130 for round-trip bus fare from L.A. to S.F. The promotional information 130 includes a selectable link 132 (e.g., a hyperlink) that a user of the client computing device 100 can select to receive more information regarding the promotion (e.g., selection can cause the client computing device 100 to request a web page regarding the bus fare promotion). The display 126 also includes promotional information 134 regarding round-trip airfare from L.A. to S.F., and a selectable link 136 for the user to request more information regarding the airfare promotion. The promotional information 130 and 134 corresponds to the promotional information P1 and P5, respectively.

FIG. 2 is a diagram of an example system 200 for providing promotional information based upon modes of transportation. The system 200 includes a client computing device 202 that request content (e.g., driving directions, maps, results to search queries, etc.) through a network 204 from a content server system 206 (e.g., a directions server system, a search engine, etc.). The content server system 206 can cause mode of transportation-related promotional information to be provided from a promotional information server system 208 to the client computing device 202 (directly or indirectly) with the requested content. The promotional information server system 208 is similar to the promotional information server system 104 described above with regard to FIG. 1. The client computing device 202 and the content server system 206 are similar to the client computing device 100 and the directions server system 102, as described above with regard to FIG. 1.

The client computing device 202 can be any of a variety of computing devices, such as a laptop computer, a desktop computer, a netbook, a mobile telephone, a smartphone, a tablet computing device, and/or a computer server system. The client computing device 202 includes an input/output (I/O) interface 210 that the device 202 uses to communicate with other computing devices over the network 204. The I/O interface 210 can be any of a variety of communications interfaces, such as an Ethernet card, a wireless network card, a cellular network transceiver, or any combination thereof. The client computing device 202 includes a content request module 212 that is configured to provide requests for content to the content server system 206 over the network 204. The content request module 212 can be configured to make such requests in response to user input, such as a user selecting a link and/or button provided by an electronic document (e.g., web page). The client computing device 202 can also include a content presentation module 214 that is configured to provide (e.g., display, audibly play, etc.) content and promotional information on the client computing device 202.

The network 204 can be any of a variety of networks over which computing devices can communicate. For instance, the network 204 can include a LAN, a WAN, a VPN, a wireless network, the Internet, a point-to-point network, a telephone network (e.g., public switched telephone network (PSTN)), a cellular telephone network, a 3G/4G network, or any combination thereof.

The content server system 206 can be any of a variety of computing devices, such as a desktop computer, a laptop computer, a distributed computer server system, a dedicated computer server system, and/or a colocated computer server system. The content server system 206 is configured to serve requested content to various computing devices, such as the client computing device 202. The content server system 206 can be configured to serve a variety of content, such driving directions, maps, search queries, and/or travel information. For example, the content server system 206 can be a search engine. In another example, the content server system 206 can be a driving directions server system.

The content server system 206 includes an I/O interface 216 that is configured to communicate with other computing devices over the network 204. The I/O interface 216 can be similar to the I/O interface 210 of the client computing device 202. The content server system 206 further includes a content request receiving module 218 that is configured to receive requests for content, such as requests from the client computing device 202. The content request receiving module 218 can cause a content serving component 220 of the content server system 206 to identify and serve the content requested by the client computing device 202. The content serving component 220 access a content data repository 222 to identify/serve at least some of the requested content. The content data repository 222 can be any of a variety of mechanisms for storing data, such as a database and/or a file system.

As part of processing a received request for content, the content request receiving module 218 can also cause a request for promotional information to be provided to the promotional information server system 208.

The promotional information server system 208 can be any of a variety of computing devices, such as a desktop computer, a laptop computer, a distributed computer server system, a dedicated computer server system, and/or a colocated computer server system. The promotional information server system 208 is configured to provide, at least, mode of transportation-related promotional information for presentation with content from the content server system 206, similar to the promotional information server system 104 described above with regard to FIG. 1. The promotional information server system 208 includes an I/O interface 224 that is similar to the I/O interfaces 210 and 216, as described above, and that is configured to receive requests for promotional information.

The promotional information server system 208 also includes a promotional information request processing module 226 that is configured to determine whether to provide mode of transportation-related promotional information in response to a received request. The promotional information request processing module 226 can make such a determination in a similar manner as the determination to provide mode of transportation-related promotional information discussed above with regard to the promotional information server system 104. The promotional information request processing module 226 can also identify information associated with a request from the client computing device 202, such as a mode of transportation that is associated with the request (e.g., identify automobile as a mode of transportation when the client computing device 202 has requested driving directions) and/or start/destination locations associated with such the request. For example, the promotional information request processing module 226 can identify start and/or destination locations based on information provided in a request from the client computing device 202 and/or other information, such as a current geographic location associated with the client computing device 202.

The promotional information server system 208 can also include an alternate mode of transportation component 228 that is configured to identify modes of transportation that are alternatives to a mode of transportation associated with a request from the client computing device 202. For instance, if the client computing device 202 has requested driving directions, alternative modes of transportation can be identified as airplanes and trains.

The alternate mode of transportation component 228 can interact with one or more of the data repositories 230a-c to make such a determination. The data repositories 230a-c include: a promotional information repository 230a that is configured to store promotional information (e.g., text ads, video ads, audio public service announcements, etc.) and details regarding promotional information (e.g., mode of transportation, start location, destination location, bid, etc.); a mode of transportation repository 230b that is configured to store information regarding modes of transportation, such as information identifying alternative modes of transportation and/or information indicating various details regarding when modes of transportation are likely to be relevant to requesting users (e.g., distance thresholds); and a user behavior data repository 230c that is configured to store user behavior data that indicates how users have interacted with mode of transportation-related promotional information previously. The alternate mode of transportation component 228 can access, at least, the mode of transportation repository 230b when identifying alternative modes of transportation to a mode of transportation associated with a request from the client computing device 202.

A user behavior module 232 of the promotional information server system 208 can identify and analyze user behavior that is relevant to a request from a client computing device 202. For instance, the user behavior module 232 can identify user behavior data from the user behavior data repository 230c regarding previous user requests that are similar to a current request from the client computing device 202. Such user behavior data can be used by a mode of transportation component 234, which is configured to identify one or more modes of transportation that are likely to be relevant to a user of the client computing device 202. The mode of transportation component 234 can make such a determination based on information and analysis provided by the promotional information request processing module 226, the alternate mode of transportation component 228, and/or the user behavior module 232. Such a determination can be made in a manner similar to the determination discussed with regard to the promotional information server system 104.

A promotional information module 236 of the promotional information server system 208 can select promotional information to provide to the client computing device 202 based on, at least, the one or more modes of transportation identified by the mode of transportation component 234. The promotional information module 236 can use a variety of techniques to select promotional information, similar to the techniques described with regard to the promotional information server system 104. For instance, the promotional information module 236 can perform an auction to select mode of transportation-related promotional information from the promotional information repository 230a.

The promotional information module 236 can provide selected promotional information to the content server system 206 through the I/O interface 224 and the network 204. The content server system 206 can integrate the selected promotional information with the requested content such that the promotional information is presented on the client computing device 202 in conjunction with the requested content. For example, the content server system 206 can add code to an electronic document that includes the requested content that causes the promotional information to be displayed as part of the document.

The content server system 206 can provide the requested content to the client computing device 202 using the content serving component 220, the I/O interface 216, and the network 204. The client computing device 202 can receive the requested content and the selected promotional information through the interface 210 and can present the requested content and/or selected promotional information to a user of the client computing device 202 using the content presentation module 214.

In some implementations, the content server system 206 can provide code to client with the requested content that, when interpreted and/or executed by the client computing device 202, can cause the client computing device 202 to request promotional information from the promotional information server system 208. In such implementations, the promotional information server system 208 can provide promotional information to the client computing device 202 through the network 204, instead of providing selected promotional information to the content server system 206. The code provided to the client computing device 202 can include code to receive and present promotional information from the promotional information server system 208 on the client computing device 202.

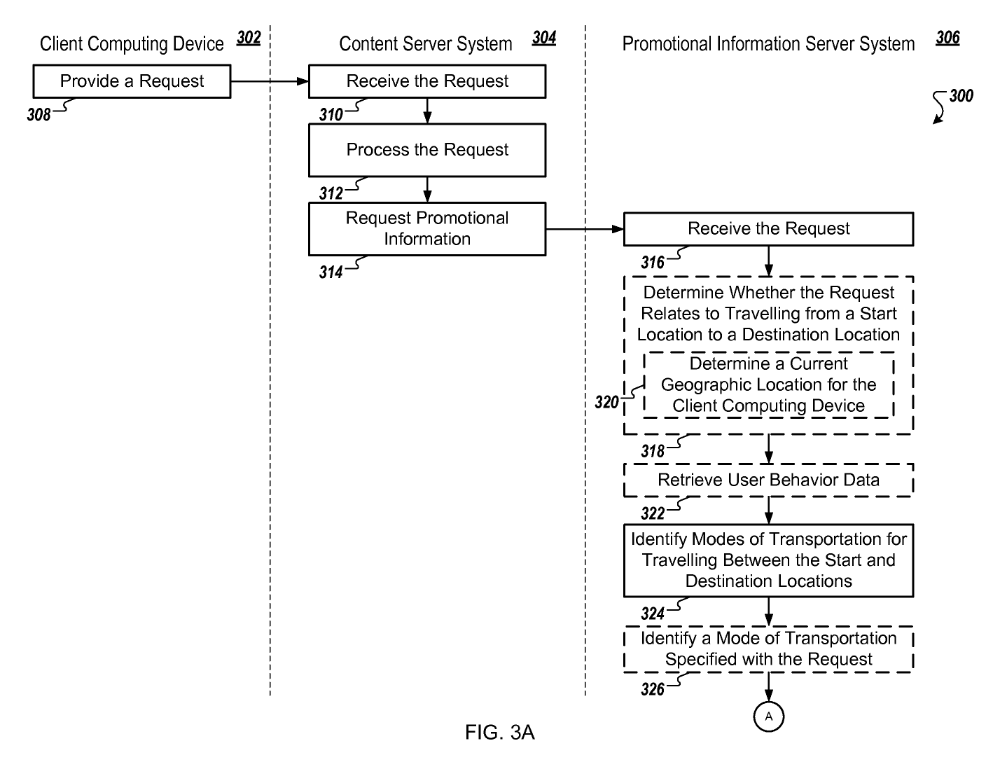

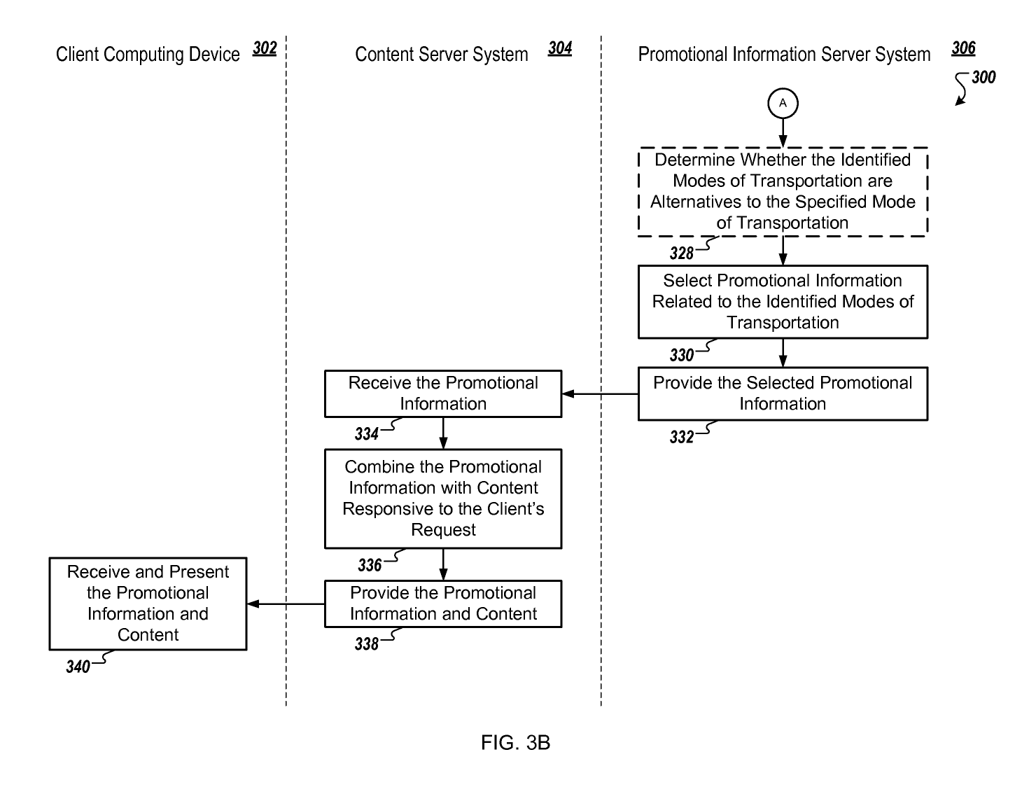

FIGS. 3A-B depict a flowchart showing an example technique 300 for providing promotional information based upon modes of transportation. Portions of the technique 300 are depicted as being performed by a client computing device 302, a content server system 304, and a promotional information server system 306. The client computing device 302 can be any of a variety of computing device, such as the client computing device 100 or 202 described above with regard to FIGS. 1 and 2, respectively. The content server system 304 can be any of a variety of computer server systems, such as the directions server system 102 or the content server system 206 described above with regard to FIGS. 1 and 2, respectively. The promotional information server system 306 can be any of a variety of server system, such as the promotional information server system 104 or 208 described above with regard to FIGS. 1 and 2, respectively.

Referring to FIG. 3A, the technique 300 starts at step 308 by the example client computing device 302 providing a request for content to the example content server system 304. For example, the client computing device 302 can request driving directions from a start location to a destination location from the content server system 304.

The content server system 304 receives the request from the client computing device 302 (step 310) and begins processing the request (step 312). Processing the request can include identifying the content requested by the client computing device 302, such a driving directions or results to a search query. Processing a request can also include preparing and/or formatting the requested content for transmission to the client computing device 302 so that the content can be properly presented to a user of the client computing device. As part of preparing and/or formatting, one or more electronic documents (e.g., HTML documents, XML documents, etc.) can be generated and/or retrieved by the content server system 304.

In addition to processing the request at step 312, the content server system 304 can request promotional information from the promotional information server system 306 (step 314) in response to receiving the request from the client computing device 302.

The promotional information server system 306 receives the request for promotional information from the content server system 304 (step 316) and, in some implementations, determines whether the request relates to travelling from a start location to a destination location (step 318). As described above with regard to the promotional information server system 104, such a determination can be used by the promotional information server system 306 to determine whether to provide mode of transportation-related promotional information with the content requested by the client computing device 302. For example, a search query “vacation Las Vegas” can be determined to be related to travelling between a user's current location (a start location that is not mentioned in the query) and Las Vegas (a destination location).

When the request is determined to relate to travelling between locations, but the start location is not specified, the current geographic location for the client computing device 302 can be determined (step 320) and can be inferred as a start location. As discussed above with regard to FIG. 1, a variety of techniques can be used to determine a current geographic location for the client computing device 302, such as an IP address lookup and/or geographic location information (e.g., GPS data) provided by the client computing device 302.

In some implementations, user behavior data can be retrieved (step 322) and used by the promotional information server system 306 to determine whether to provide mode of transportation-related promotional information with the requested content and/or to select mode of transportation-related promotional information to provide to the client computing device 302.

The promotional information server system 306 can identify one or more modes of transportation for travelling between the start and destination locations (step 324). Such a determination can be made based on a distance between the start location and the destination location. For example, if the distance exceeds a threshold, the promotional information server system 306 can identify airplanes as at least one of the modes of transportation that should be presented to the client computing device 302.

In some implementations, the promotional information server system 306 can identify a mode of transportation specified with the request from the client computing device 302 (step 326). For example, if the client computing device 302 requests driving directions form the content server system 304, the mode of transportation associated with the request can be determined to be automobiles.

Referring to FIG. 3B, in some implementations the promotional information server system 306 can determine whether to identified modes of transportation are alternatives to the specified mode of transportation in the request (step 328). The promotional information server system 306 can make such a determination to narrow the group of modes of transportation to those that are alternatives to the specified mode of transportation that are likely to be relevant to a user of the client computing device 302.

The promotional information server system 306 can select promotional information related to the identified modes of transportation (step 330). A variety of techniques can be used to select promotional information, such as conducting an auction. The promotional information server system 306 can provide the selected promotional information to the content server system 304 (step 332). In some implementations, the promotional information server system 306 can provide the promotional information to the client computing device 302 instead of to the content server system 304, as described above with regard to FIG. 2.

The content server system 304 receives the promotional information (step 334) and combines the promotional information with content that is responsive to the request from the client computing device 302 (step 336). For example, code that causes the promotional information to be presented can be added to an electronic document that includes at least a portion of the requested content. The promotional information and the content can be provided by the content server system 304 to the client computing device 302 (step 338).

The client computing device can receive and present the content and promotional information (step 340). For example, if the client computing device 302 requests web page with driving directions from the content server system 304, the client computing device 302 can receive a web page with the requested directions and alternative mode of transportation promotional information, like airfare and bus fare promotional information. The client computing device 302 can display the web page and promotional information to a user of the client computing device 302 using a variety of hardware and/or software components, such as a display screen, speakers, a web browser application, and/or scripting applications.

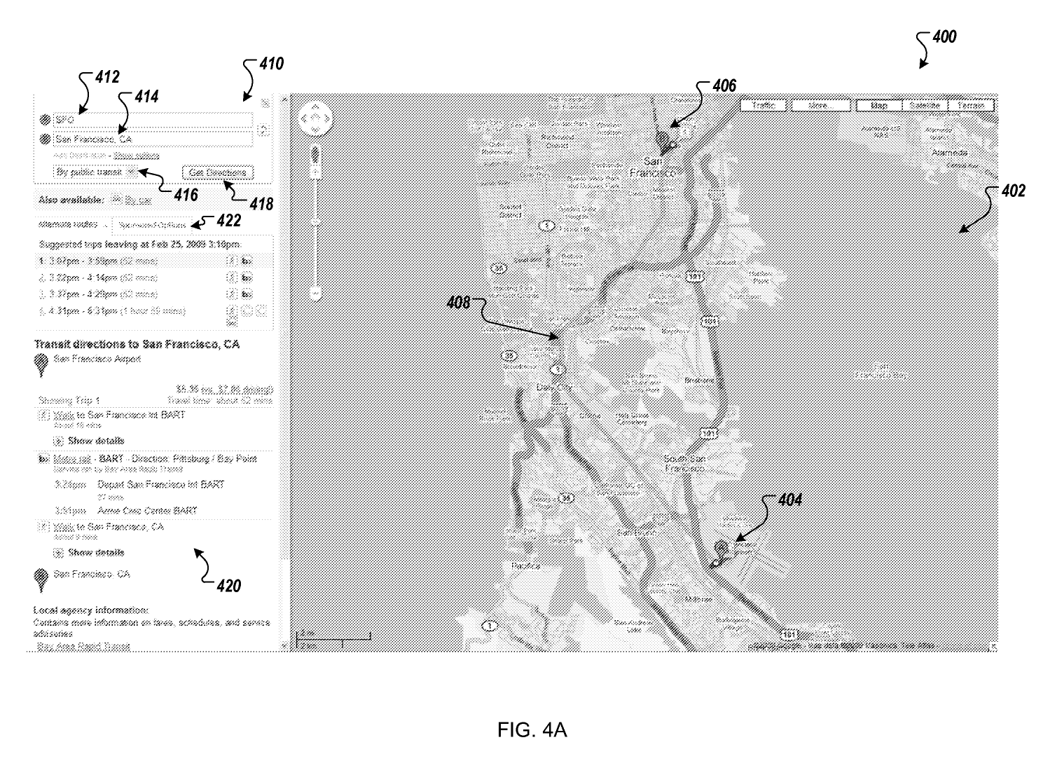

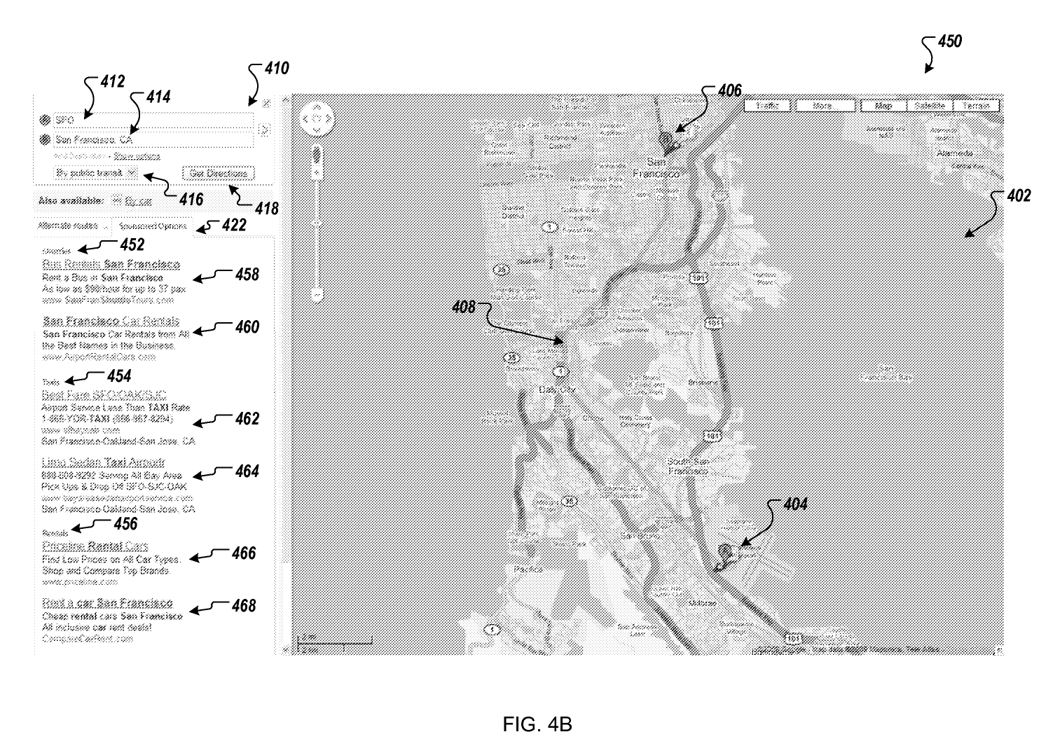

FIGS. 4A-B are screenshots 400 and 450 of an example application providing mode of transportation-related promotional information with directions. The example screenshots 400 and 450 can be from any of a variety of applications, such as a web browser. The screenshots 400 and 450 can be provided on a variety of computing devices, such as the client computing devices 100, 202, and/or 302 discussed above with regard to FIGS. 1, 2, and 3A-B, respectively.

Referring to FIG. 4A, the screenshot 400 includes a map 402 that includes a marker A (404) indicating a start location and a marker B (406) indicating a destination location for the directions being presented. The marker A is placed at the San Francisco Airport (SFO) and the marker B is placed in downtown San Francisco. The map 402 also includes a highlighted route 408 for the directions from the marker A to the marker B.

The screenshot 400 also includes a text-based frame 410 that includes an interface for requesting directions and a text-based version of the directions depicted in the map 402. The interface includes a start location field 412 and a destination field 414 that include information identifying the start location (SFO) and destination location (San Francisco, Calif.) for the directions. The interface also includes a drop-down menu 416 that can be used to select a mode of transportation for the directions. In this example screenshot 400, the selected mode of transportation is “public transit.” The interface also includes a button 418 that can selected by a user to cause a client computing device to transmit a request for directions by the specified mode of transportation (drop-down menu 416) from the specified start location (field 412) to the specified destination location (field 414).

The text-based frame 410 includes text-based directions 420 for travelling from the start location to the destination location by public transit. The text-based frame 410 also includes a selectable tab 422 for sponsored options for travelling from SFO to San Francisco. Sponsored options in this example include promotional information regarding modes of transportation for travelling from SFO to San Francisco.

Referring to FIG. 4B, the screenshot 450 depicts the screenshot 400 after the sponsored options tab 422 has been selected. The sponsored options include promotional information regarding shuttles 452, taxis 454, and car rentals 456—three alternative modes of transportation from SFO to San Francisco. Promotional information 458-468 that is associated with one or more of the three alternative modes of transportation 452-456 are presented in the sponsored options tab 422. The mode of transportation-related promotional information 458-468 can provide a user with alternatives to public transportation from SFO to San Francisco that the user may not have previously known about. This promotional information 458-468 can be identified and provided with the requested content (directions) using one or more of the techniques described above with regard to FIGS. 1, 2, and/or 3A-B.

Various additional information not depicted in the screenshot 450 can be provided with the promotional information 458-468. For example, comparison information can be presented when appropriate. Comparison information can include information that provides a comparison of the specified mode of transportation (public transit) and the alternative modes of transportation (452-456). For instance, a comparison of the estimated travel time and/or price for using each mode of transportation can be provided. Such information may be helpful to a user when deciding between the mode of transportation that he/she specified and an alternative mode of transportation that is being presented as another option to the user.

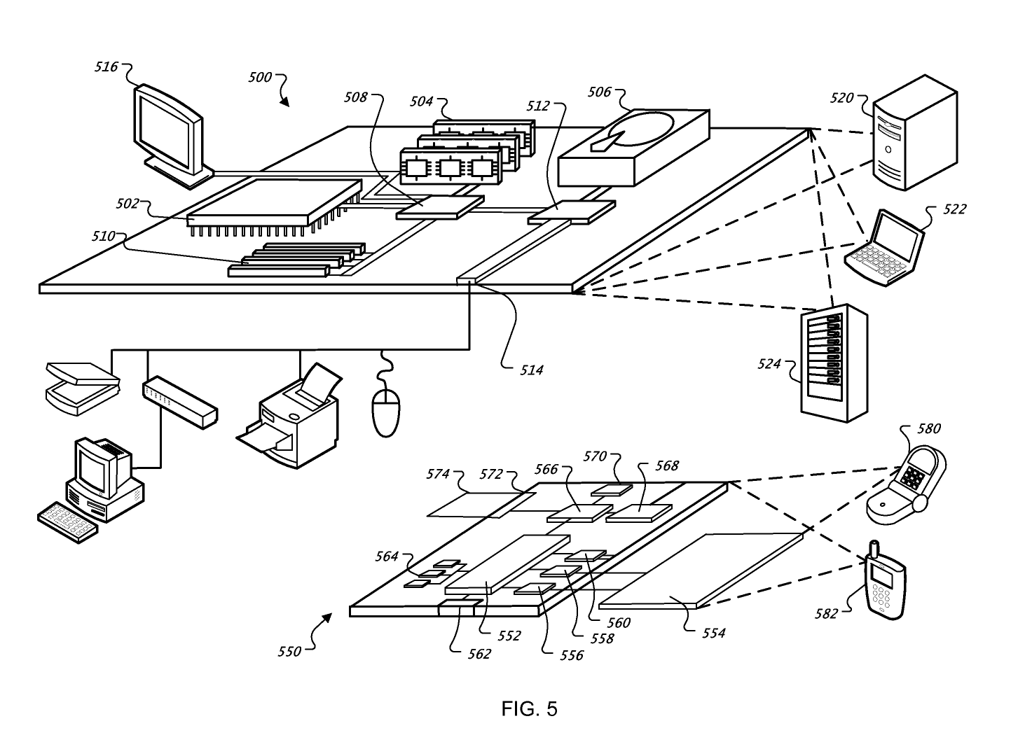

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for providing promotional information based upon modes of transportation may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A computer-implemented method comprising:
receiving at a server system a request from a client computing device for directions from a start geographic location to a destination geographic location via a first mode of transportation, wherein the request from the client computing device explicitly identifies the first mode of transportation as driving;
determining that the start geographic location is more than a threshold distance from the destination geographic location;
in response to determining that the start geographic location is more than a threshold distance from the destination geographic location, determining to provide mode of transportation-related promotional information relating to a different mode of transportation from the first mode of transportation;
selecting by the server system a second mode of transportation from a plurality of modes of transportation, each of the plurality of modes of transportation being for traveling an entire route from the start geographic location to the destination geographic location between which the client computing device requested driving directions, wherein the second mode of transportation is different from the first mode of transportation;
selecting by the server system promotional information related to the second mode of transportation to provide to the client computing device; and
providing by the server system and to the client computing device the selected promotional information with directions to guide a user of the client computing device from the start geographic location to the destination geographic location according to the first mode of transportation.

2. The method of claim 1, wherein the promotional information corresponds to a service or product provided by a third-party transportation provider for traveling from the start location to the destination location.

3. The method of claim 1, wherein the promotional information comprises a user-selectable advertisement that, upon selection on the client computing device, directs the client computing device to a web page that provides additional information regarding the promotional information.

4. The method of claim 1, further comprising identifying the first mode of transportation from the received request.

5. (canceled)

6. The method of claim 1, wherein identifying the second mode of transportation further comprises:
determining a distance between the start geographic location and the destination geographic location; and
identifying the second mode of transportation based upon the distance between the start geographic location and the destination geographic location.

7. The method of claim 1, wherein identifying the second mode of transportation comprises:
retrieving user behavior data that indicates how users previously interacted with promotional information that was previously provided with previous directions and that was previously selected based on modes of transportation for the associated previous directions; and
identifying the second mode of transportation based upon the retrieved user behavior data.

8. The method of claim 7, wherein the retrieved user behavior data is associated with directions from the start geographic location to the destination geographic location

9. The method of claim 1, wherein the request is received by the server system as a search query;
the method further comprising determining that the received request relates to directions from the start geographic location to the destination geographic location.

10. The method of claim 9, further comprising:
determining a current geographic location for the client computing device and using the current geographic location as the start geographic location; and
identifying a destination geographic location from the search query.

11. (canceled)

12. The method of claim 1, wherein the directions provided to the client computing device comprise directions for driving from the start geographic location to the destination geographic location and wherein the selected promotional information provided to the client computing device relates to flying from the start geographic location to the destination geographic location.

13. The method of claim 1, wherein the second mode of transportation is selected from the group consisting of: cars, taxis, trains, buses, boats, airplanes, bicycles, walking, and motorcycles.

14. A system for providing promotional information to a client computing device in response to a request for directions, the system comprising:
one or more servers;
an interface for the one or more servers to receive a request from the client computing device for directions from a start geographic location to a destination geographic location via a first mode of transportation, wherein the request explicitly indicates a selection of the first mode of transportation from a plurality of different modes of transportation;
a mode of transportation component to identify a second mode of transportation for traveling an entire route from the start geographic location to the destination geographic location, wherein the second mode of transportation is different from the first mode of transportation; and
a promotional information module to select promotional information related to the second mode of transportation and to provide to the client computing device the selected promotional information with directions from the start geographic location to the destination geographic location according to the first mode of transportation.

15. The system of claim 14, wherein the promotional information relates to a service or product provided by a third-party transportation provider for traveling from the start geographic location to the destination geographic location via the second mode of transportation.

16. The system of claim 14, further comprising a request processing module that identifies the first mode of transportation in the received request for the requested directions.

17. The system of claim 16, further comprising an alternate mode of transportation component to identify the second mode of transportation as an alternative to the first mode of transportation.

18. A system for providing promotional information to a client computing device in response to a request for directions, the system comprising:
one or more servers;
an interface for the one or more servers to receive a request from the client computing device for directions from a start geographic location to a destination geographic location via a first mode of transportation;
means for identifying a second mode of transportation for traveling an entire route from the start geographic location to the destination geographic location, wherein the second mode of transportation is different from the first mode of transportation, wherein the request identifies the first mode of transportation;
a promotional information module to select promotional information related to the second mode of transportation and to provide to the client computing device the selected promotional information with directions from the start geographic location to the destination geographic location according to the first mode of transportation.

19. The system of claim 18, wherein the promotional information relates to a service or product provided by a third-party transportation provider for traveling from the start geographic location to the destination geographic location via the second mode of transportation.

20. The system of claim 18, further comprising a request processing module that identifies the first mode of transportation in the received request for directions.

21. The method of claim 7, wherein the retrieved user behavior data is associated with directions for travelling a distance that is within a threshold of a distance between the start geographic location and the destination geographic location.
